(19) United States
(12) Patent Application Publication
(10) Pub. No.: US 2021/0070053 A1
(43) Pub. Date: Mar. 11, 2021

(54) INK JET RECORDING APPARATUS

(71) Applicant: KYOCERA Document Solutions Inc., Osaka (JP)

(72) Inventor: Yasutaka INUI, Osaka (JP)

(73) Assignee: KYOCERA Document Solutions Inc., Osaka (JP)

(21) Appl. No.: 17/009,027

(22) Filed: Sep. 1, 2020

(30) Foreign Application Priority Data
Sep. 6, 2019 (JP) 2019-163197

(51) Int. Cl. B41J 2/165

(52) U.S. Cl. CPC B41J 2/16535

(57) ABSTRACT

An ink jet recording apparatus includes a recording head, a wiper element, and a controller. The recording head includes a cleaning solution supplier, an ink ejecting surface, and an abutment member. To perform a cleaning operation, the controller causes a cleaning solution to be squeezed from a cleaning solution outlet, moves the wiper element over the ink ejecting surface in a wiping direction, from a travel start position where the wiper element contacts with the cleaning solution supplier, to an end position corresponding to the abutment member, moves the wiper element away from the end position in a vertical descending direction, and performs, a predetermined number of times, an operation including: bringing the wiper element into contact with the abutment member by moving the wiper element in a vertical ascending direction; and moving the wiper element in the vertical descending direction to separate from the abutment member.

### INCORPORATION BY REFERENCE

This application claims priority to Japanese Patent Application No. 2019-163197 filed on Sep. 6, 2019, the entire contents of which are incorporated by reference herein.

### BACKGROUND

The present disclosure relates to an ink jet recording apparatus, and in particular to a technique to clean an ink ejecting surface of a recording head.

An ink jet recording apparatus is known that ejects ink from a nozzle of a recording head onto a recording medium such as a paper sheet, to thereby record an image on the recording medium. Such an ink jet recording apparatus is configured to perform a cleaning operation, including moving a plate-shaped wiper element in a wiping direction with the distal edge portion thereof kept in contact with an ink ejecting surface, thereby wiping the ink ejecting surface, to prevent the ink ejected from the nozzle of the recording head from being stuck to the nozzle surface.

In this cleaning operation, the wiper element reaches a side edge of the ink ejecting surface, which is the terminal edge thereof, after moving in the wiping direction in contact with the ink ejecting surface and finishing the cleaning of the ink ejecting surface. At the side edge, the wiper element is released from the state of being pressed by the ink ejecting surface in contact therewith, and therefore the wiper element recovers the straight posture free from the pressure, from the bent posture forced by the pressure. At this point, the ink scraped off from the ink ejecting surface by the wiper element, and stuck thereto, splashes around owing to the force of the elastic deformation of the wiper element that takes place when the wiper element recovers the straight posture from the bent posture. In such a case, regions in the apparatus where the ink that has splashed remains may suffer contamination or deterioration, which may further lead to malfunction of the apparatus.

According to a first technique developed to solve the foregoing drawback, the entirety of the wiper element is brought into contact with a blade interference member of a sloped shape (hereinafter, abutment member) provided beside the recording head, to suppress sudden elastic deformation of the wiper element. According to a second technique, the abutment member is formed of a material having a high liquid absorption capacity, so that the ink stuck to the wiper element can be effectively collected.

### SUMMARY

The disclosure proposes further improvement of the foregoing technique.

In an aspect, the disclosure provides an ink jet recording apparatus including a recording head, a wiper element, a driver device, a control device, and an abutment member. The recording head includes an ink ejecting surface, oriented downward and including a plurality of ink outlets through which ink is ejected, and a cleaning solution supplier. The wiper element is formed in a plate shape, and configured to perform a cleaning operation including wiping the ink ejecting surface by moving in a predetermined wiping direction, with a distal edge portion of the wiper element kept in contact with the ink ejecting surface with pressure. The driver device drives the wiper element. The control device includes a processor, and acts as a controller when the processor executes a control program. The controller controls the driver device to cause the wiper element to perform the cleaning operation. The abutment member is provided downstream of the ink ejecting surface in the wiping direction, to be contacted by the distal edge portion of the wiper element, after the wiper element has wiped the ink ejecting surface. To control the cleaning operation, the controller moves the wiper element to pass over the ink ejecting surface in the wiping direction, from a travel start position where the wiper element is in contact with the cleaning solution supplier, to an end position corresponding to the abutment member, moves the wiper element in a vertical descending direction at the end position, and performs, a predetermined number of times, an operation including: bringing the wiper element into contact with the abutment member by moving the wiper element in a direction opposite to the vertical descending direction; and moving the wiper element in the vertical descending to separate the wiper element from the abutment member direction.

### BRIEF DESCRIPTION OF THE DRAWINGS

FIG. 1 is a front cross-sectional view showing a configuration of an ink jet recording apparatus according to an embodiment of the disclosure.

FIG. 2 is a front cross-sectional view showing a state where a conveying device has been moved downward to a maintenance position, and a cleaning device has been moved to a position right under a recorder.

FIG. 3 is a functional block diagram showing an essential internal configuration of the ink jet recording apparatus according to the embodiment.

FIG. 4 is a schematic front view of the recorder and the conveying device.

FIG. 5 is a plan view of the conveying device and the recorder, seen from above.

FIG. 6A is a partially seen-through side view showing a state where an ink tray and a wiper unit of the cleaning device are located under the recorder.

FIG. 6B is a schematic drawing showing an ink ejecting surface of a recording head, viewed from below.

FIG. 7 is a schematic drawing showing the ink ejecting surface and wiper elements, viewed from below.

FIG. 8A to FIG. 8E are partially seen-through side views, for explaining a cleaning operation.

FIG. 9A and FIG. 9B are partially seen-through side views, for explaining a cleaning operation that follows the operation of FIG. 8E.

FIG. 10A is a table showing the composition of ink used for an experiment.

FIG. 10B is a graph showing amounts of residual ink on an abutment member, which differ depending on a number of times that the wiper element was brought into contact with the abutment member, after the same amount of ink of FIG. 10A was applied thereto.

FIG. 11A to FIG. 11D are partially seen-through side views, for explaining a cleaning operation according to a first variation that follows the operation of FIG. 8E.

FIG. 12A is a schematic drawing showing the ink ejecting surface and wiper elements according to a second variation, viewed from below.

FIG. 12B is a schematic drawing showing the ink ejecting surface and wiper elements according to a third variation, viewed from below.

### DETAILED DESCRIPTION

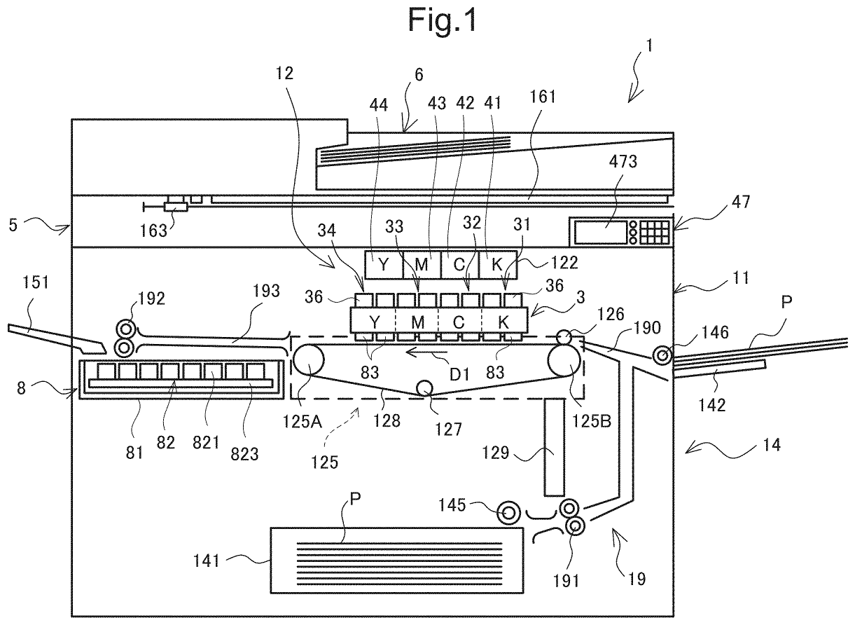

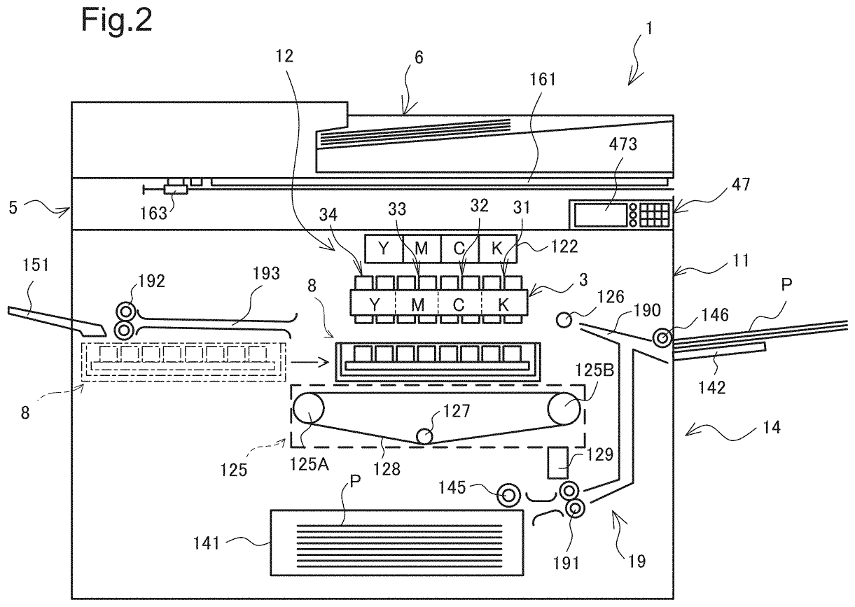

Hereafter, an ink jet recording apparatus according to an embodiment of the disclosure will be described, with reference to the drawings. FIG. 1 is a front cross-sectional view showing a configuration of the ink jet recording apparatus according to the embodiment of the disclosure. FIG. 2 is a front cross-sectional view showing a state where a conveying device has been moved downward to a maintenance position, and a cleaning device has been moved to a position right under a recorder. The ink jet recording apparatus 1 is a multifunction peripheral having a plurality of functions, such as copying, printing, scanning, and facsimile transmission, and includes an operation device 47, a document feeding device 6, a document reading device 5, an image recording device 12, a paper feeding device 14, a paper transport mechanism 19, a conveying device 125, and a cleaning device 8, which are provided on or inside a main body 11.

The operation device 47 is for receiving instructions from a user to execute the functions and operations that the ink jet recording apparatus 1 is configured to perform, for example an image recording operation. The operation device 47 includes a display device 473 for displaying, for example, an operation guide for the user.

To perform the document reading operation, the ink jet recording apparatus 1 operates as follows. The document reading device 5 optically reads the image on a source document delivered from the document feeding device 6 or placed on a platen glass 161, and generates image data. The image data generated by the document reading device 5 is stored, for example, in a non-illustrated image memory.

The document reading device 5 includes a reading mechanism 163 having a light emitter and a charge coupled device (CCD) sensor, to illuminate a source document with the light emitter having a light source, and receive the reflected light with the CCD sensor, thereby reading the image from the source document.

To perform the image forming operation, the ink jet recording apparatus 1 operates as follows. The image recording device 12 forms an image on a recording sheet P, delivered from the paper feeding device 14 and transported by the paper transport mechanism 19, on the basis of the image data generated through the document reading operation, stored in the image memory, or received from a computer connected via a network.

The paper feeding device 14 includes a paper cassette 141. A feed roller 145 is provided on the upper side of the paper cassette 141, to feed the recording sheet P stored in the paper cassette 141 toward a transport route 190.

The paper feeding device 14 also includes a manual bypass tray 142, attached to a wall face of the main body 11 so as to be opened and closed. The recording sheet P set on the manual bypass tray 142 is delivered to the transport route 190 by a feed roller 146.

The paper transport mechanism 19 includes the transport route 190 through which the recording sheet P is transported from the paper feeding device 14 to an output tray 151, a transport roller pair 191 located at a predetermined position on the transport route 190, and a discharge roller pair 192.

The recording sheet P delivered from the paper feeding device 14 is introduced into the transport route 190 by the transport roller pair 191. The recording sheet P, on which an image has been formed by the image recording device 12, is transported along an outgoing transport route 193 (part of the transport route 190) in a face-up orientation, and then discharged to the output tray 151 by the discharge roller pair 192.

The paper transport mechanism 19 also includes a non-illustrated offset mechanism, configured to displace the discharge roller pair 192 in a right angle direction with respect to the recording sheet transport direction, to shift the recording sheet P to be discharged to the output tray 151 in the width direction of the recording sheet.

The image recording device 12, configured to record the image based on the document image data, on the recording sheet P delivered from the paper feeding device 14 and transported along the transport route 190, includes a conveying device 125, an adsorption roller 126, a recorder 3, and an ink tank 122.

The conveying device 125 includes a drive roller 125A, a follower roller 125B, a tension roller 127, and a conveyor belt 128. The conveyor belt 128 is an endless belt, wound over the drive roller 125A, the follower roller 125B, and the tension roller 127. The drive roller 125A is driven to rotate counterclockwise by a non-illustrated motor, so that, when the drive roller 125A is driven, the conveyor belt 128 runs counterclockwise, and the follower roller 125B and the tension roller 127 are made to also rotate counterclockwise.

The tension roller 127 serves to maintain the tension of the conveyor belt 128 at an appropriate level. The adsorption roller 126 is opposed, in contact with the conveyor belt 128, to the follower roller 125B, and charges the conveyor belt 128 so as to electrostatically adsorb the recording sheet P, delivered from the paper feeding device 14, to the conveyor belt 128.

The recorder 3 ejects ink droplets of four different colors (black, cyan, magenta, and yellow) onto the recording sheet P being transported by the paper transport mechanism 19, thereby sequentially recording an image. In the ink tank 122, ink of the corresponding color is loaded.

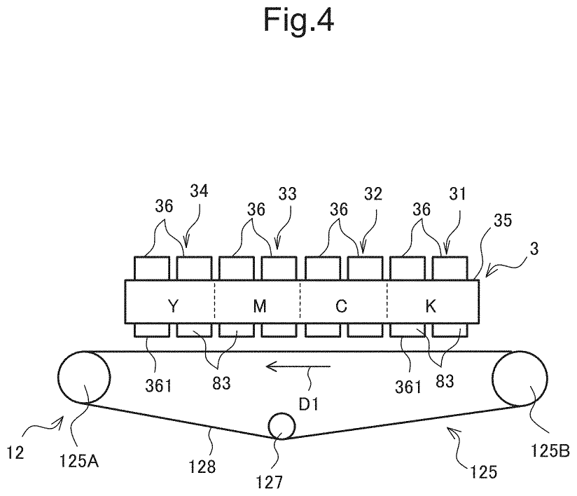

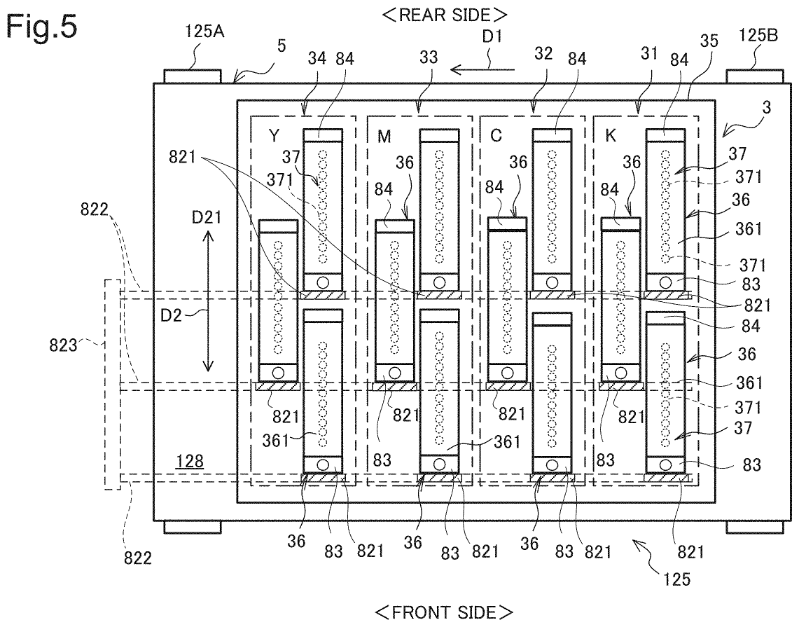

To be more detailed, the recorder 3 includes line heads 31, 32, 33, and 34, respectively corresponding to black, cyan, magenta, and yellow. Thus, the ink jet recording apparatus 1 is a line-head ink jet recording apparatus. The recorder 3 also includes a head frame 35 (see FIG. 4 and FIG. 5) supporting the line heads 31 to 34. The head frame 35 is supported by the main body 11.

The conveying device 125 is supported by an elevation mechanism 129 from below, and moved up and downward with respect to the line heads 31 to 34. In other words, the elevation mechanism 129 relatively moves the conveying device 125 with respect to the line heads 31 to 34, so as to locate the conveying device 125 close to and away from the line heads 31 to 34. More specifically, the elevation mechanism 129 moves the conveying device 125 between a recording position that enables the recorder 3 to execute printing (position shown in FIG. 1), and a maintenance position displaced downward from the recording position by a predetermined distance (position shown in FIG. 2).

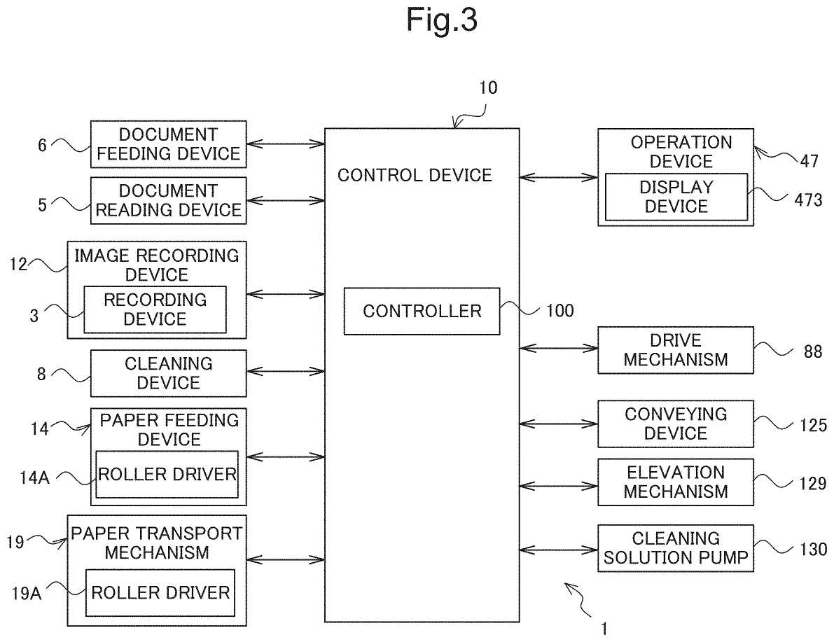

FIG. 3 is a functional block diagram showing an essential internal configuration of the ink jet recording apparatus according to the embodiment. The ink jet recording apparatus 1 includes the control device 10, the document feeding device 6, the document reading device 5, the image recording device 12, the paper feeding device 14, the paper transport mechanism 19, the operation device 47, the conveying device 125, the elevation mechanism 129, a drive mechanism 88, a cleaning solution pump 130, and the cleaning device 8.

The paper feeding device 14 and the paper transport mechanism 19 respectively include roller drivers 14A and 19A. The roller drivers 14A and 19A each include a motor, gears, and a driver. The roller driver 14A serves as an energy source that gives rotative force to the feed rollers 145 and 146. The roller driver 19A serves as an energy source that gives rotative force to the respective drive rollers of the transport roller pair 191 and the discharge roller pair 192.

The control device 10 includes a processor, a random-access memory (RAM), a read-only memory (ROM), and an exclusive hardware circuit. The processor is, for example, a central processing device (CPU), an application specific integrated circuit (ASIC), or a micro processing device (MPU). The control device 10 includes a controller 100.

The control device 10 acts as the controller 100, when the processor operates according to a control program stored in a built-in non-volatile memory. Here, the controller 100 may be constituted in the form of a hardware circuit, instead of being realized by the operation of the control device 10 according to the control program. This also applies to other embodiments, unless otherwise specifically noted.

The controller 100 controls the overall operation of the ink jet recording apparatus 1. The controller 100 is connected to the document feeding device 6, the document reading device 5, the image recording device 12, the paper feeding device 14, the paper transport mechanism 19, the cleaning device 8, the operation device 47, the conveying device 125, the elevation mechanism 129, the drive mechanism 88, and the cleaning solution pump 130, to control the operation of the mentioned components.

The controller 100 controls the operation of the drive mechanism 88, thereby causing a wiper element 821 to perform a cleaning operation including wiping an ink ejecting surface 361 with cleaning solution 831, as will be subsequently described. The drive mechanism 88 includes a rack-and-pinion mechanism and a drive source (e.g., drive motor), to drive the wiper element 821.

The configuration of the recorder 3 will be described in detail hereunder, with reference to the drawings. FIG. 4 illustrates the recorder and the conveying device. FIG. 5 illustrates the conveying device and the recorder viewed from above.

As shown in FIG. 4, the conveying device 125 is located under the line heads 31 to 34. The conveying device 125 conveys the recording sheet P opposed to the ink ejecting surface 361. The gap between the conveyor belt 128 and the ink ejecting surface 361 is adjusted such that the gap between the surface of the recording sheet P and the ink ejecting surface 361 during the printing operation becomes, for example, 1 mm.

The recorder 3 includes the line heads 31 to 34, as shown in FIG. 5. The line heads 31 to 34 are elongate in a direction D2 (width direction of recording sheet P), orthogonal to the transport direction D1 of the recording sheet P The line heads 31 to 34 each have a width corresponding to the width of the widest recording sheet P that can be transported. The line heads 31 to 34 are fixed to the head frame 35, at predetermined intervals along the transport direction D1 of the recording sheet P The line heads 31 to 34 each include a plurality (in this embodiment, three) of recording heads 36. Accordingly, the recorder 3 has twelve recording heads 36.

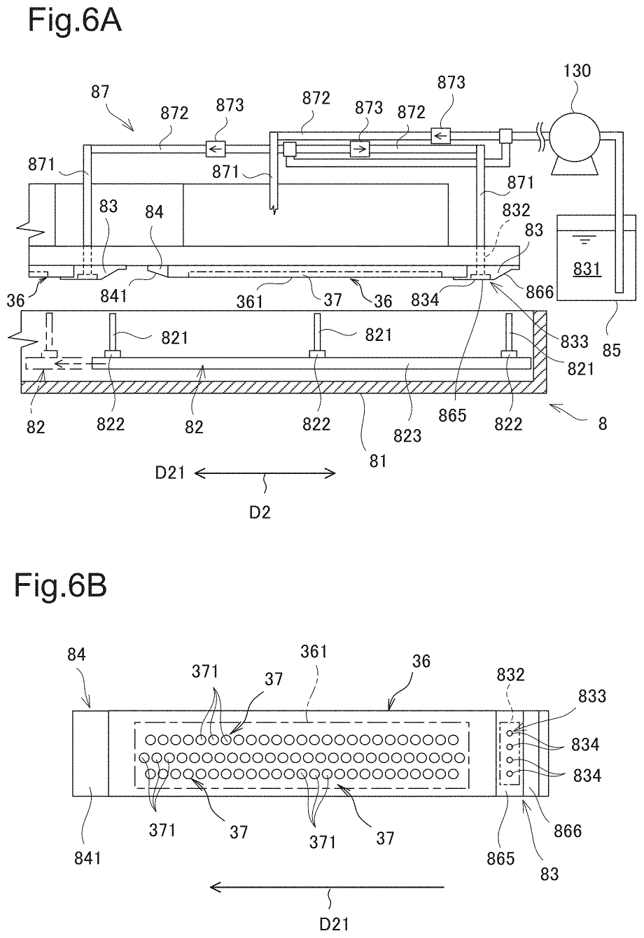

The recording head 36 includes a plurality of ink nozzles 37 each having an ink outlet 371, from which the ink is ejected. Here, although the plurality of ink nozzles 37 are simply illustrated in a single row in FIG. 5, actually the nozzles 37 are aligned in three rows in a checkerboard pattern, as shown in FIG. 6B to be subsequently referred to. The lower face of the recording head 36 (opposed to the recording sheet P) is configured as the ink ejecting surface 361 oriented downward and having the ink outlet 371. In this embodiment, the line head 31 includes three recording heads 36, arranged in a checkerboard pattern along the direction D2. Likewise, the remaining line heads 32 to 34 each include three recording heads 36, arranged in a checkerboard pattern along the direction D2.

The recorder 3 is configured to eject the ink from the ink nozzles 37 of the respective recording heads 36 onto the recording sheet P being transported by the conveying device 125, to thereby record an image on the recording sheet P The ink may be ejected from the line heads 31 to 34 by, for example, a piezoelectric method using a piezoelectric element, or a thermal method including generating bubbles by heat.

As shown in FIG. 1, the ink tank 122 includes ink tanks 41, 42, 43, and 44 in which black, cyan, magenta, and yellow ink is respectively stored. The ink tanks 41 to 44 are respectively connected to the line heads 31 to 34 of the corresponding color, via a non-illustrated ink tube. Thus, the ink is supplied from the ink tanks 41 to 44 to the line heads 31 to 34, respectively. The ink employed in the ink jet recording apparatus 1 is normally formed of a solvent or water, containing a color material corresponding to each color.

The cleaning device 8 will now be described, with reference to FIG. 6A and FIG. 6B. FIG. 6A is a partially seen-through side view showing a state where an ink tray and a wiper unit of the cleaning device are located under the recorder. FIG. 6B is a schematic drawing showing an ink ejecting surface of a recording head, viewed from below.

The cleaning device 8 performs the cleaning operation (purging inclusive) when the conveying device 125 is located at the maintenance position as shown in FIG. 2, to thereby recover the function of the respective recording heads 36 of the line heads 31 to 34. The cleaning device 8 includes an ink tray 81, a wiper unit 82, and the drive mechanism 88, as shown in FIG. 1 and FIG. 6A.

The ink tray 81 is for receiving the ink discharged from the ink nozzles 37 of the respective recording heads 36. The ink tray 81 is supported by a non-illustrated first moving mechanism, so as to move in a horizontal direction (left-right direction in FIG. 1). The first moving mechanism is a known drive mechanism, for example including a rack and pinion mechanism that converts the rotary motion of a gear coupled to a rotary shaft of a motor into a linear motion, to horizontally move the ink tray 81. The ink tray 81 is usually (e.g., during the printing operation) located at a retracted position downstream of the recorder 3 in the transport direction D1 (indicated by dash-dot lines in FIG. 2.

When an instruction to perform the cleaning operation is inputted by the user through the operation device 47, the controller 100 causes the elevation mechanism 129 to move the conveying device 125 to the maintenance position, and causes the first moving mechanism to move the ink tray 81 to a space created in a region opposite the line heads 31 to 34 (indicated by solid lines in FIG. 2). The ink tray 81 is also supported so as to move in a vertical direction (up-down direction in FIG. 1). Upon reaching the position opposite the line heads 31 to 34, the ink tray 81 is moved upward, by the operation of the elevation mechanism 129 to move the conveying device 125 upward from the maintenance position by a predetermined distance.

The wiper unit 82 includes a plurality of wiper elements 821 for cleaning the ink stuck to the ink ejecting surface 361, each supported by a pair of side frames 823 via a stay 822. The wiper unit 82 is movable along the direction D2. More specifically, the plurality of wiper elements 821 are movable in a wiping direction D21 from a cleaning solution supplier 83, in contact with the ink ejecting surface 361 of the recording head 36.

The plurality of wiper elements 821 each clean the ink ejecting surface 361 with the cleaning solution 831 supplied from the cleaning solution supplier 83, by moving in the wiping direction D21.

A cleaning solution container 85 is provided for storing the cleaning solution 831, as shown in FIG. 6A. The cleaning solution 831 may be obtained by excluding color materials from the ink. In other words, the cleaning solution 831 may be predominantly composed of a solvent and water. The cleaning solution 831 may further contain a surfactant, a preservative, a fungicide, or the like, as the case may be.

The plurality of wiper elements 821 are each formed of, for example, an elastomer, in a plate shape in a thickness of 1 mm to 2 mm, and thus possess elasticity. Examples of the suitable elastomer include urethane rubber, ethylene propylene diene monomer (EPDM), nitrile rubber (NBR), styrene rubber (SBR), chloroprene rubber, silicone rubber, and fluororubber. The wiper element 821 is formed in a plate shape, and installed such that the flat portion is orthogonal to the ink ejecting surface 361. Further, the wiper element 821 is moved in a predetermined wiping direction, namely the direction D2, with the distal edge portion pressed against the ink ejecting surface 361, thereby performing the cleaning operation including wiping the ink ejecting surface 361.

The plurality of stays 822 each extend along the transport direction D1. The stays 822 each have both end portions connected to the side frame 823. In other words, the plurality of stays 822 are provided between the pair of side frames 823 installed parallel to each other, and perpendicular thereto. In this embodiment, three stays 822 are provided. The stays 822 each extend in the direction in which the plurality of line heads 31 to 34 for the respective colors are aligned, as indicated by broken lines in FIG. 5. As also shown in FIG. 5, the line heads 31 to 34 each include three recording heads 36. The three recording heads 36 included in each of the line heads 31 to 34 are located at the same position in the direction D2, as the respectively corresponding recording heads 36 in the other line heads, and aligned in the direction in which the stays 822 extend. The stays 822 are each located so as to pass along one end portion of the recording heads 36 aligned at the same position in the direction D2 in the respective line heads 31 to 34. On each of the stays 822, the wiper elements 821 are fixed at the positions respectively opposed to the four recording heads 36 aligned as above (totally four wiper elements 821 on each of the stays 822). The number of wiper elements 821 is twelve, in accordance with the number of recording heads 36.

The pair of side frames 823 can be moved in the direction D2, by the drive mechanism 88 (see FIG. 3). The drive mechanism 88 includes, for example, a rack and pinion mechanism, like the first driving mechanism. For example, when rotating force supplied by the drive source (e.g., drive motor) of the drive mechanism 88 is applied to the side frame 823 acting as the rack, via a non-illustrated pinion gear of the drive mechanism 88, the side frame 823 is caused to reciprocate along the direction D2. Accordingly, the entirety of the wiper unit 82, the stays 822 and the plurality of wiper elements 821 inclusive, is caused to reciprocate along the direction D2. Thus, the wiper elements 821 each wipe the ink ejecting surface 361 of the recording head 36, opposed to the wiper elements 821. The side frame 823, the stay 822, and the drive mechanism 88 exemplify the driver device What is claimed is.

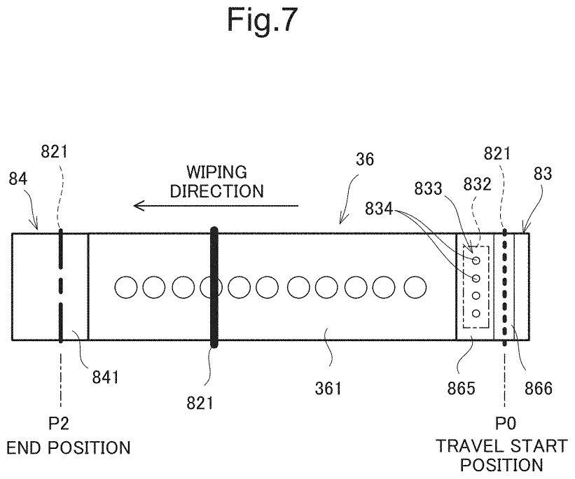

Referring to FIG. 7, the posture of the wiper element 821 will be described. When the ink ejecting surface 361 and the wiper element 821 are viewed from below, the wiper element 821 is oriented such that the distal edge portion extends in the direction orthogonal to the wiping direction. The wiper element 821 is driven by the side frames 823, the stays 822, and the drive mechanism 88, under the control of the controller 100, to move in the direction D2 maintaining the mentioned orientation, with the distal edge portion kept in contact with the ink ejecting surface 361, thus performing the cleaning operation.

The distal edge portion of the wiper element 821 is formed so as to overlap with the ink ejecting surface 361 by a predetermined length (e.g., 2 mm). Accordingly, the wiper element 821 is distorted by the pressure from the ink ejecting surface 361, upon being brought into contact therewith.

The recording head 36 includes a cleaning solution supplier 83, located upstream of the ink ejecting surface 361 in the wiping direction D21, as shown in FIG. 6A and FIG. 6B. The cleaning solution supplier 83 is located upstream of the ink ejecting surface 361, in the wiping direction D21, and includes a cleaning solution supplying surface 865 having a cleaning solution outlet 834, from which the cleaning solution 831 for wiping the ink ejecting surface is supplied to the wiper element 821.

The cleaning solution supplier 83 also includes a sloped surface 866, continuously extending from the cleaning solution supplying surface 865 to the upstream side in the wiping direction D21, and inclined upward with respect to the cleaning solution supplying surface 865, toward the upstream side in the wiping direction D21.

The recorder 3 includes twelve cleaning solution suppliers 83, because of having twelve recording heads 36 as shown in FIG. 5. The twelve cleaning solution suppliers 83 each supply the cleaning solution 831 for cleaning the ink ejecting surface 361. The cleaning solution supplier 83 supplies, when cleaning the ink ejecting surface 361 with the wiper element 821, the cleaning solution 831 stored in a space 832, through a cleaning solution nozzle 833 communicating with the space 832.

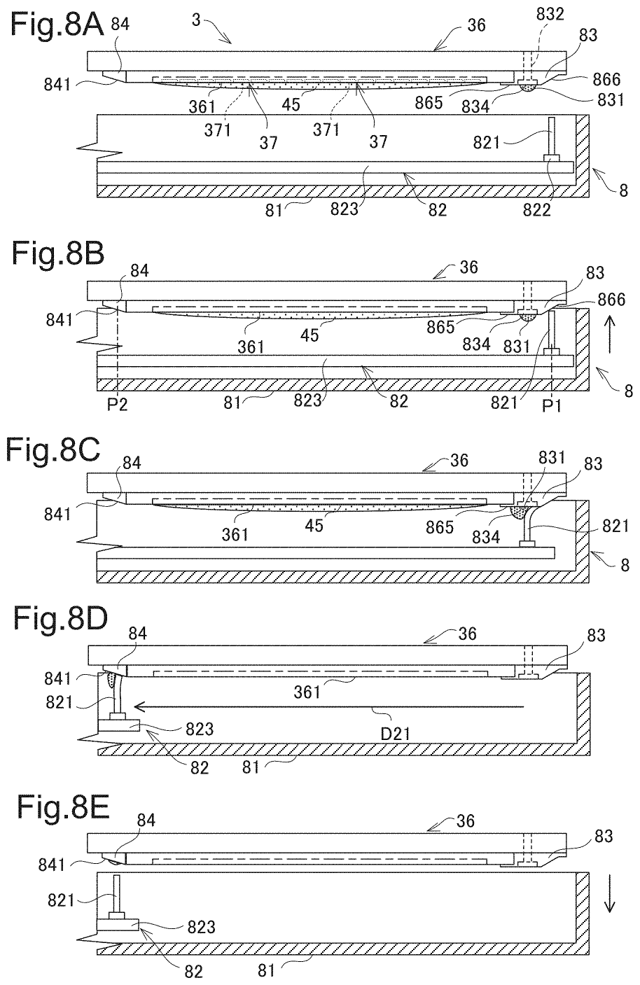

As shown in FIG. 8A to be subsequently referred to, the cleaning solution 831 protrudes in a semispherical shape from the cleaning solution outlet 834 of the cleaning solution nozzle 833, when supplied to clean the ink ejecting surface 361. In contrast, in occasions other than the cleaning of the ink ejecting surface 361, the cleaning solution 831 forms a concave meniscus inside the cleaning solution nozzle 833. The concave meniscus can be formed by appropriately adjusting the inner diameter of the cleaning solution nozzle 833, and the negative pressure applied by the space 832 to the inside of the cleaning solution nozzle 833.

Further, the recording head 36 includes, as shown in FIG. 6A and FIG. 6B, an abutment member 84 located downstream of the ink ejecting surface 361 in the wiping direction D21. The abutment member 84 is located adjacent to the end portion of the recording head 36 (ink ejecting surface 361) in the wiping direction D21, so that the distal edge portion of the wiper element 821 contacts the abutment member 84, after the wiper element 821 has wiped the ink ejecting surface 361.

As shown in FIG. 7, when the ink ejecting surface 361 and the wiper element 821 are viewed from below, the size of the abutment member 84 in the direction orthogonal to the wiping direction is the same as the width of the ink ejecting surface 361 in the same direction.

FIG. 8A to FIG. 8E are partially seen-through side views for explaining the cleaning operation.

In FIG. 8A, the controller 100 supplies purge ink 45 to the recording head 36, so that the purge ink 45 is discharged from the ink outlet 371 of the ink nozzle 37. Accordingly, thickened ink, foreign matters, and bubbles inside the ink nozzle 37 are discharged toward the ink tray 81, together with the purge ink 45 supplied to the ink nozzle 37. Such a purging operation eliminates clogging of the ink nozzle 37. The ink and other substances discharged to the ink tray 81 are discharged to a predetermined waste ink deposit, from a drain port provided on the bottom portion of the ink tray 81, through a non-illustrated ink tube.

When the purging operation is finished, the cleaning device 8 performs the cleaning operation. The cleaning operation is performed to wipe off the purge ink 45 stuck to the ink ejecting surface 361 with the wiper element 821. In the cleaning operation, the controller 100 squeezes out a predetermined amount (e.g., 1.5 mL) of cleaning solution 831, so that the cleaning solution 831 is supplied in a semispherical shape protruding from the cleaning solution outlet 834 of the cleaning solution supplier 83 (see FIG. 8A). Here, the predetermined amount (e.g., 1.5 mL) is the total amount for all the line heads 31 to 34, in other words for all the four colors. The cleaning solution 831 may be supplied at the same time that, before, or after the purge ink 45 is discharged.

Referring to FIG. 8B to FIG. 8D, upon supplying the cleaning solution 831, the controller 100 drives the drive mechanism 88 to horizontally move the wiper unit 82 in the wiping direction D21. To be more detailed, the controller 100 locates the wiper element 821 at a travel start position P1 (see FIG. 8B), and then moves the wiper element 821 from the travel start position P1 as far as an end position P2 (see FIG. 8D) where the wiper element 821 contacts the abutment member 84. In this process, as shown in FIG. 8B to FIG. 8D, the wiper element 821 moves along the sloped surface 866, the cleaning solution outlet 834, and the ink ejecting surface 361, in contact therewith, until contacting the abutment member 84.

As shown in FIG. 8D, the plurality of wiper elements 821 each wipe off the purge ink 45 stuck to the ink ejecting surface 361, while moving along the ink ejecting surface 361 in contact therewith, and then reach the abutment member 84 after passing over the side edge, in other words the terminal edge, of the ink ejecting surface 361. The residual ink and other substances wiped off by the wiper element 821 either move together with the wiper element 821, or move downward together with the cleaning solution 831 along the surface of the wiper element 821, and then drop to the ink tray 81. Therefore, no liquid is left over on the ink ejecting surface 361.

When the wiper element 821 finishes to clean the ink ejecting surface 361 by moving in the wiping direction in contact with the ink ejecting surface 361, the wiper element 821 passes the side edge of the ink ejecting surface 361, which is the terminal edge thereof, and reaches the end position P2 corresponding to the abutment member 84. Here, description will be given on the elastic deformation of the wiper element 821 that takes place when the wiper element 821 reaches the end position P2 after passing over the ink ejecting surface 361.

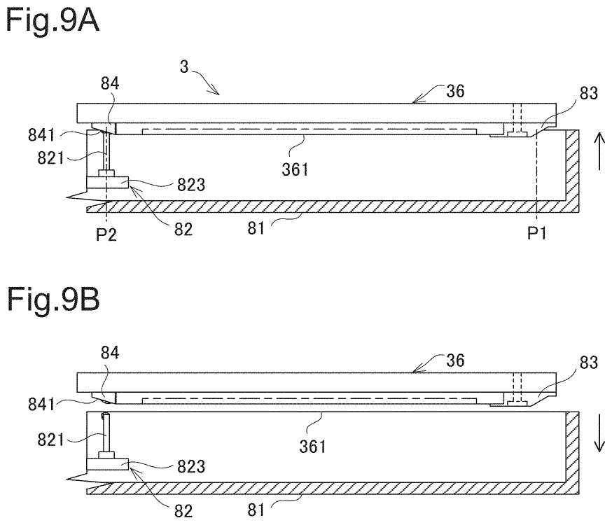

As shown in FIG. 7, FIG. 9A, and FIG. 9B, the abutment member 84 includes a sloped surface 841. The sloped surface 841 continuously extends from the ink ejecting surface 361 to the downstream side in the wiping direction D21, and is inclined upward with respect to the ink ejecting surface 361, toward the downstream side in the wiping direction D21. In other words, the abutment member 84 is formed as the sloped surface 841, such that a contact surface contacting with the distal edge portion of the wiper element 821 becomes apart from the distal edge portion (i.e., pressure of the surface in contact with the distal edge portion of the wiper element 821 against the distal edge portion is reduced), as the wiper element 821 moves farther away from the ink ejecting surface 361 in the wiping direction.

Accordingly, the distortion of the wiper element 821 is gradually reduced while the wiper element 821 advances in the wiping direction D21 in contact with the sloped surface 841 of the abutment member 84, and finally the distal edge portion of the wiper element 821 is gently parted from the sloped surface 841, when the wiper element 821 reaches the end position P2. Therefore, the elastic deformation of the wiper element 821 that takes place when the distal edge portion is released from the pressure of the sloped surface 841 is reduced, which leads to minimized splash of the ink.

In addition, the abutment member 84 is, for example, formed of a polyacetal resin (POM). The ink ejecting surface 361 of the recording head 36 is provided with, for example, a fluorine-based water-repellent film. The sloped surface 841 of the abutment member 84 is less ink repellent than the ink ejecting surface 361. Therefore, the ink that has been scraped off is induced to migrate to the sloped surface 841 of the abutment member 84, rather than to the ink ejecting surface 361.

Then the controller 100 drives the elevation mechanism 129 to move the conveying device 125 downward by a predetermined distance (e.g., several millimeters), as shown in FIG. 8E.

As described above, to control the cleaning operation, the controller 100 squeezes out the purge ink 45 from the ink outlet 371 of the recording head 36, and also the cleaning solution 831 from the cleaning solution outlet 834, moves the wiper element 821 in the wiping direction D21 from the travel start position P1 over the ink ejecting surface 361, until reaching the end position P2 where the wiper element 821 contacts the abutment member 84, and then moves the wiper element 821 vertically downward by the predetermined distance, at the end position P2.

Further, after moving the wiper element 821 vertically downward away from the end position P2 by the predetermined distance as shown in FIG. 8E, the controller 100 performs, a predetermined number of times (in this embodiment, twice), the operation including moving the wiper element 821 in the opposite direction (i.e., upward) by the predetermined distance thereby bringing the wiper element 821 in contact with the abutment member 84 as shown in FIG. 9A, and again moving the wiper element 821 vertically downward away from the abutment member 84, as shown in FIG. 9B.

The controller 100 then drives the elevation mechanism 129 to cause the conveying device 125 to descend to the maintenance position as shown in FIG. 2, and drives the drive mechanism 88 to cause the ink tray 81 of the cleaning device 8 to return to the retracted position (see FIG. 1). Further, the controller 100 drives the elevation mechanism 129 to cause the conveying device 125 to return to the recording position (position shown in FIG. 1).

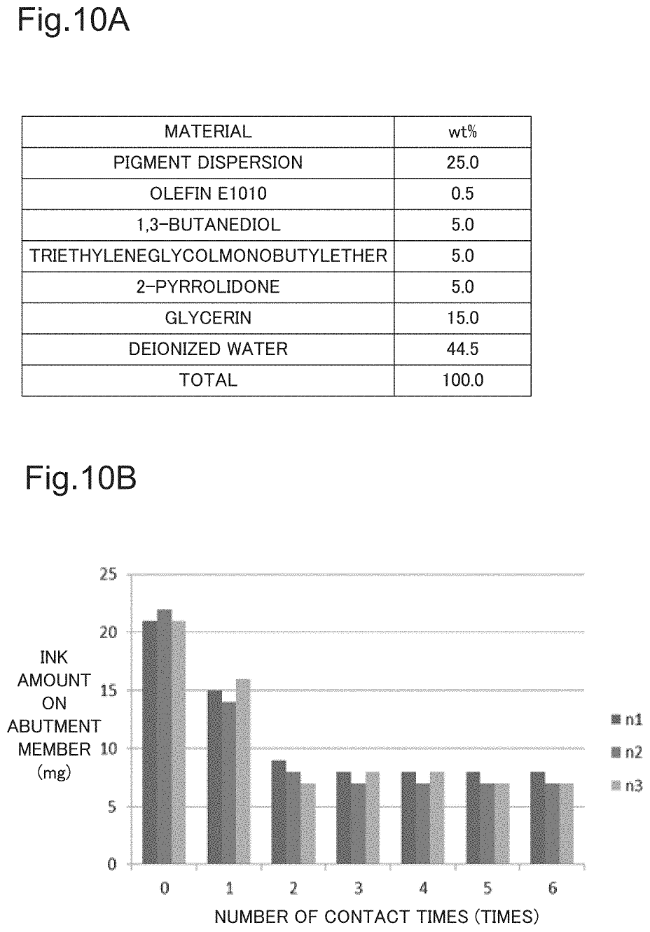

Referring to FIG. 10A and FIG. 10B, description will be given on experiment results of the amount of residual ink on the abutment member 84, which differs depending on the number of times that the wiper element 821 was brought into contact with the abutment member 84. FIG. 10A is a table showing the composition of ink used for the experiment. FIG. 10B is a graph showing the amounts of the residual ink on the abutment member, which differ depending on the number of times that the wiper element 821 was brought into contact with the abutment member, wo which the same amount of ink of FIG. 10A was applied.

The mixture having the composition of FIG. 10A was sufficiently stirred and filtrated under pressure through a filter having a pore diameter of 5 μm, to obtain the ink that can be used as a recording liquid. A predetermined amount of this ink was applied to the abutment member 84, and an operation including moving upward the wiper element 821 at the end position P2 so as to contact the abutment member 84 as shown in FIG. 9A, and moving downward the wiper element 821 away from the abutment member 84 as shown in FIG. 9B, was performed 0 times, once, twice, three times, and up to six times, each time the ink was applied to the abutment member 84. Here, the codes n1, n2, and n3 in FIG. 10B respectively correspond to the three recording heads 36 of one of the line heads 31, 32, 33, and 34.

As shown in FIG. 10B, when the wiper element 821 was brought into contact with the abutment member 84 0 times, the amount of the residual ink on the abutment member 84 of the three recording heads 36 exceeded 20 mg.

As also shown in FIG. 10B, when the wiper element 821 was brought into contact with the abutment member 84 once, the amount of the residual ink on the abutment member 84 of the three recording heads 36 was approximately 15 mg, which is less than the case of 0 times.

As shown in FIG. 10B, further, when the wiper element 821 was brought into contact with the abutment member 84 twice, the amount of the residual ink on the abutment member 84 of the three recording heads 36 was approximately 7 to 8 mg, which is less than the case of once.

As shown in FIG. 10B, further, when the wiper element 821 was brought into contact with the abutment member 84 three times, the amount of the residual ink on the abutment member 84 of the three recording heads 36 was approximately 7 to 8 mg, which is similar to the case of twice. When the wiper element 821 was brought into contact with the abutment member 84 four times to six times also, the amount of the residual ink on the abutment member 84 was similar to the case of twice.

In view of the experiment results shown in FIG. 10B, it has been confirmed that bringing the wiper element 821 into contact with the abutment member 84 twice reduces the amount of the residual ink on the abutment member 84, compared with the case of once. However, it has also been confirmed that bringing the wiper element 821 into contact with the abutment member 84 three or more times only provides the similar results to the case of twice.

In the cleaning operation according to the foregoing embodiment, the controller 100 causes the cleaning solution to be squeezed out from the cleaning solution outlet 834, moves the wiper element 821 to pass over the ink ejecting surface 361 in the wiping direction, from the travel start position P1 where the wiper element 821 is in contact with the cleaning solution supplier to the end position P2 corresponding to the abutment member 84, and moves the wiper element 821 vertically downward at the end position P2. Therefore, the ink can be scraped off from the ink ejecting surface 361, by the wiper element 821. However, when the wiper element 821 is separated from the abutment member 84 at the end position P2, some ink remains on the abutment member 84. Accordingly, after moving the wiper element 821 vertically downward at the end position P2, the controller 100 performs, a predetermined number of times, the operation including moving the wiper element 821 in the opposite direction (i.e., upward) thereby bringing the wiper element 821 in contact with the abutment member 84, and moving the wiper element 821 vertically downward away from the abutment member 84. Thus, a part of the ink remaining on the abutment member 84 can be transferred to the wiper element 821, by causing the wiper element 821 to contact and move away from the abutment member 84, and therefore the amount of the residual ink on the abutment member 84 can be reduced, compared with the case where the wiper element 821 is not made to contact and move away from the abutment member 84, at the end position P2. Consequently, appearance of defective images originating from the residual ink on the abutment member 84, transferred from the wiper element 821, can be prevented.

Now, with the first and second techniques according to the background art, although the abutment member prevents the ink from splashing owing to the elastic deformation of the wiper element, the ink scraped off by the wiper element is transferred to the abutment member, and remains thereon. Since the abutment member has a size corresponding to the entire width of the wiper element, a large amount of ink remains on the abutment member, when the wiping is finished. Accordingly, since the abutment member is located beside the recording head, the ink on the abutment member may stick to the recording sheet, when the recording sheet passes by the abutment member in the printing process. This may lead to appearance of defective images originating from the stain of the recording sheet produced by the abutment member.

With the configuration according to this embodiment, in contrast, appearance of defective images, originating from the ink transferred from the wiper element and stuck to the abutment member, can be prevented.

The controller 100 performs twice the operation of causing the wiper element 821 to contact and move away from the abutment member 84, and therefore the ink stuck to the abutment member 84 can be efficiently reduced. More specifically, it has been confirmed, according to the experiment results shown in FIG. 10B, that causing the wiper element 821 to contact and move away from the abutment member 84 twice reduces a larger amount of ink from the abutment member 84, compared with the case of once. It has also been confirmed that causing the wiper element 821 to contact and move away from the abutment member 84 three or more times only provides the result similar to the case of twice. Thus, it has been confirmed that setting the predetermined number of times to twice is most desirable, from the viewpoint of the balance between the number of times of operation and the attained result, to efficiently reduce the amount of the residual ink on the abutment member 84.

The disclosure is not limited to the foregoing embodiment, but may be modified in various manners.

### First Variation

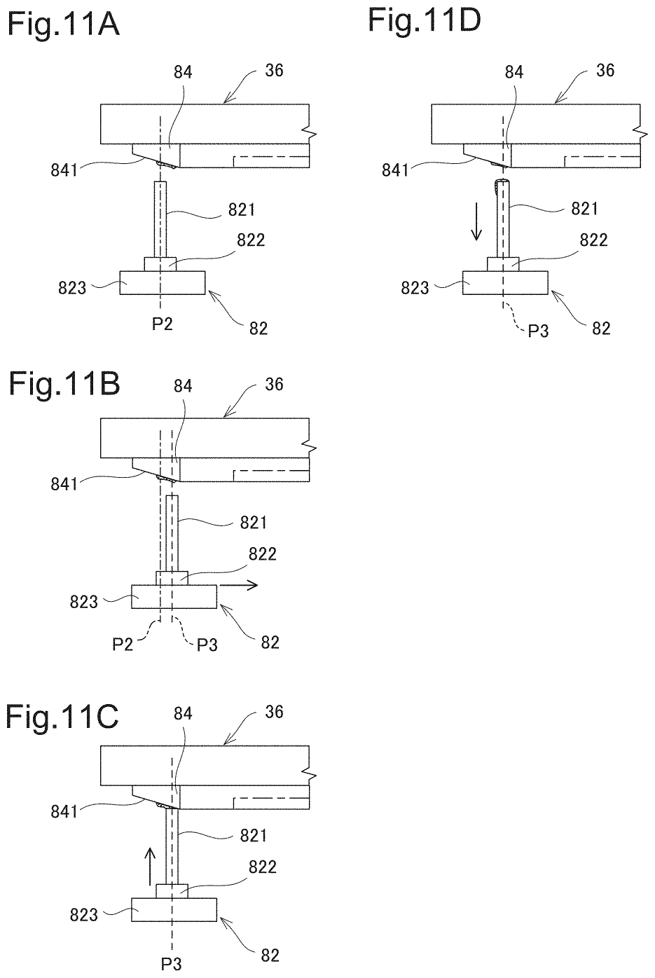

For example, although the controller 100 causes the wiper element 821 to contact and move away from the abutment member 84 at the end position P2 in the foregoing embodiment, a different arrangement may be adopted. The cleaning operation may be performed according to a first variation illustrated in FIG. 11A to FIG. 11D.

FIG. 11A to FIG. 11D are partially seen-through side views, for explaining the cleaning operation according to the first variation that follows the operation of FIG. 8E. For example, the wiper element 821 located at the end position P2 as shown in FIG. 11A may be moved in the direction opposite to the wiping direction as shown in FIG. 11B, to a predetermined position P3 corresponding to an end portion of the sloped surface 841 of the abutment member 84 adjacent to the ink ejecting surface 361, and the wiper element 821 may be made to contact and move away from the abutment member 84 at the predetermined position P3 (see FIG. 11C and FIG. 11D).

More specifically, to perform the cleaning operation, the controller 100 moves the wiper element 821, made to contact the cleaning solution supplier 83, to pass over the ink ejecting surface 361 in the wiping direction, from the travel start position P1 (see FIG. 8B) to the end position P2 corresponding to the abutment member 84 (see FIG. 8D), and moves the wiper element 821 vertically downward at the end position P2 (see FIG. 8E and FIG. 11A). Then the controller 100 moves the wiper element 821 in the direction opposite to the wiping direction, to the predetermined position P3 corresponding to the end portion of the sloped surface 841 of the abutment member 84 adjacent to the ink ejecting surface 361, as shown in FIG. 11B. Further, the controller 100 performs, a predetermined number of times (e.g., twice) the operation including moving the wiper element 821 in the opposite direction (i.e., upward) thereby bringing the wiper element 821 in contact with the abutment member 84 as shown in FIG. 11C, and moving the wiper element 821 vertically downward away from the abutment member 84, as shown in FIG. 11D.

The end portion of the sloped surface 841 of the abutment member 84 adjacent to the ink ejecting surface 361 corresponds to the lowermost position on the sloped surface 841 of the abutment member 84, and therefore the ink on the sloped surface 841 tends to concentrate at this position. Accordingly, causing the wiper element 821 to contact and move away from this end portion a predetermined number of times allows the ink concentrating at the lowermost position to be effectively reduced, and therefore the ink stuck to the abutment member 84 can be more effectively reduced. With the arrangement according to the first variation, consequently, the appearance of defective images, originating from the ink transferred from the wiper element and stuck to the abutment member, can be more effectively prevented.

### Second Variation

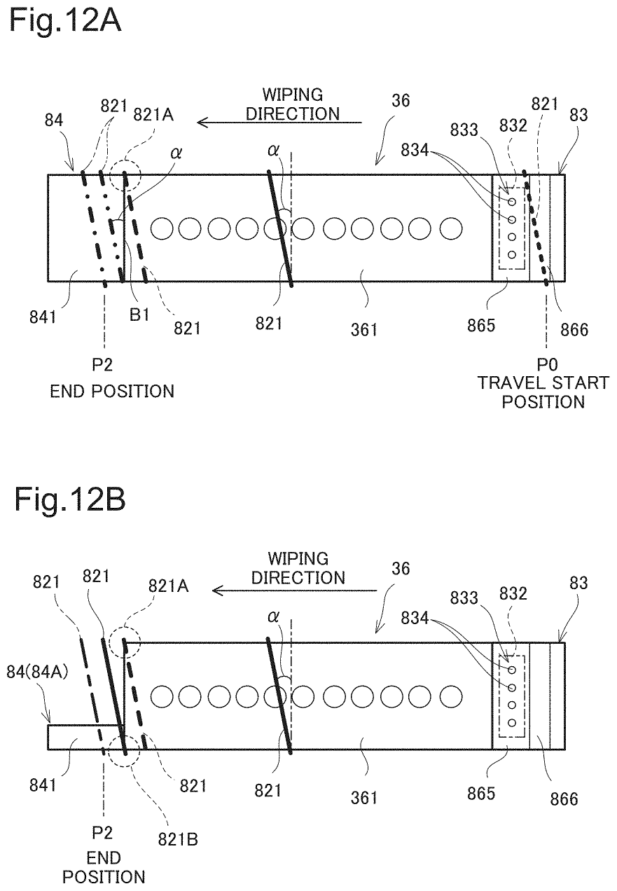

According to the foregoing embodiment and the first variation, the wiper element 821 has a plate shape, and the distal edge portion of the wiper element 821 extends in the direction orthogonal to the wiping direction, in other words the flat portion of the wiper element 821 is oriented orthogonal to the ink ejecting surface 361. Instead, as a second variation shown in FIG. 12A, the wiper element 821 may be oriented such that the distal edge portion defines a predetermined angle α with respect to the direction orthogonal to the wiping direction, the angle a being narrower than 90 degrees.

Referring to FIG. 12A, the posture of the wiper element 821 will be described. FIG. 12A is a schematic drawing showing the ink ejecting surface and wiper elements according to the second variation, viewed from below. As shown in FIG. 12A, when the ink ejecting surface 361 and the wiper element 821 are viewed from below, the wiper element 821 is oriented such that the distal edge portion defines the predetermined angle α with respect to the direction orthogonal to the wiping direction, the angle α being narrower than 90 degrees and wider than 0 degrees. The angle α may be set to any degree narrower than 90 degrees. In this variation, the angle α is set to 20 degrees. The wiper element 821 is driven by the side frames 823, the stays 822, and the drive mechanism 88, under the control of the controller 100, to move in the direction D2 maintaining the mentioned orientation, with the distal edge portion kept in contact with the ink ejecting surface 361, thus performing the cleaning operation. The abutment member 84 is formed such that the size thereof in the direction in which the distal edge portion of the wiper element 821 extends (i.e., angle α) allows the entirety of the distal edge portion oriented in the mentioned direction (i.e., direction along the angle α) to make contact, in other words allows the entirety of the wiper element 821 to make contact.

Further, as shown in FIG. 12A, when viewed in the direction orthogonal to the ink ejecting surface 361, a boundary B1 between the abutment member 84 and the ink ejecting surface 361 is linear, and the angle α between the boundary B1 and the distal edge portion of the wiper element 821 is set to an angle wider than 0 degrees (in this variation, 20 degrees).

When the wiper element 821 finishes to clean the ink ejecting surface 361 by moving in the wiping direction in contact with the ink ejecting surface 361, the wiper element 821 reaches the side edge of the ink ejecting surface 361, which is the terminal edge thereof. At this point, the wiper element 821 is oriented such that the distal edge portion is inclined by the predetermined angle α, which is narrower than 90 degrees, with respect to the direction orthogonal to the wiping direction. Accordingly, an end portion 821A of the wiper element 821 closest to the side edge reaches the side edge first, as shown in FIG. 12A, not that the entirety of the wiper element 821 in the orthogonal direction reaches the side edge at the same time. Therefore, at the side edge, the wiper element 821 is released from the pressure of the ink ejecting surface 361, at the end portion 821A which has reached the side edge first. Then the wiper element 821 starts to recover the linear posture free from the pressure, from the distorted and bent posture, starting from the end portion 821A toward the end portion opposite to the end portion 821A with time differences, as the wiper element 821 moves in the wiping direction. In this case, the force sequentially generated by the elastic deformation, which takes place when the wiper element 821 recovers the linear posture from the bent posture, is smaller than in the case where the entirety of the wiper element 821 reaches the side edge at the same time and is simultaneously released from the pressure of the ink ejecting surface 361, and therefore a less amount of the ink, scraped off from the ink ejecting surface 361 by the wiper element 821 and stuck thereto, splashes around from the wiper element 821 owing to the force of the elastic deformation.

### Third Variation

According to the second variation, the abutment member 84 is formed such that the size thereof in the direction in which the distal edge portion of the wiper element 821 extends (i.e., angle α) allows the entirety of the distal edge portion oriented in the same direction to make contact, in other words allows the entirety of the wiper element 821 to make contact. However, a different configuration may be adopted. For example, as shown in FIG. 12B, the abutment member 84 may be formed such that the size thereof in the direction in which the distal edge portion of the wiper element 821 extends (i.e., angle α) only allows a part of the distal edge portion oriented in the same direction to make contact. FIG. 12B is a schematic drawing showing the ink ejecting surface and wiper elements according to the third variation, viewed from below.

When the ink ejecting surface 361 and the wiper element 821 are viewed from below, the abutment member 84 is, as shown in FIG. 12B, formed such that the size thereof in the direction in which the distal edge portion of the wiper element 821 extends (i.e., direction of angle α) only allows a part of the distal edge portion oriented in the same direction to make contact. In other words, the abutment member 84 may be formed such that the size thereof in the direction orthogonal to the wiping direction is smaller than the width of the ink ejecting surface 361, taken in the direction orthogonal to the wiping direction.

As described above, it suffices that the abutment member 84 allows a part of the distal edge portion of the wiper element 821 in the mentioned direction (i.e., direction of angle α) to make contact. Further, it is preferable that the abutment member 84 is located at the position where the distal edge portion leaves the ink ejecting surface 361 last in the mentioned direction, in the cleaning operation performed by the wiper element 821. In this variation, the abutment member 84 is located at the position where the distal edge portion leaves the ink ejecting surface 361 last, in the cleaning operation performed by the wiper element 821. In other words, the abutment member 84 is located at the position where the distal edge portion leaves the ink ejecting surface 361 last, not where the distal edge portion leaves the ink ejecting surface 361 first, in the cleaning operation performed by the wiper element 821.

When the wiper element 821 finishes to clean the ink ejecting surface 361 by moving in the wiping direction in contact with the ink ejecting surface 361, the wiper element 821 reaches the side edge of the ink ejecting surface 361, which is the terminal edge thereof. At this point, the wiper element 821 is oriented such that the distal edge portion is inclined by the predetermined angle α, which is narrower than 90 degrees, with respect to the direction orthogonal to the wiping direction. Accordingly, the end portion 821A of the wiper element 821 closest to the side edge reaches the side edge first, as shown in FIG. 12B, not that the entirety of the wiper element 821 in the orthogonal direction reaches the side edge at the same time. Therefore, at the side edge, the wiper element 821 is released from the pressure of the ink ejecting surface 361, at the end portion 821A which has reached the side edge first. Then the wiper element 821 starts to recover the linear posture free from the pressure, from the distorted and bent posture, starting from the end portion 821A toward the end portion opposite to the end portion 821A with time differences, as the wiper element 821 moves in the wiping direction. In this case, the force sequentially generated by the elastic deformation, which takes place when the wiper element 821 recovers the linear posture from the bent posture, is smaller than in the case where the entirety of the wiper element 821 reaches the side edge at the same time and is simultaneously released from the pressure of the ink ejecting surface 361, and therefore a less amount of the ink, scraped off from the ink ejecting surface 361 by the wiper element 821 and stuck thereto, splashes around from the wiper element 821 owing to the force of the elastic deformation.

Now, an end portion 821B which reaches the side edge last (leaves the side edge last) elastically deforms more largely than other portions, when the wiper element 821 recovers the linear posture from the bent posture, because the other portions of the wiper element 821 are already released from the pressure of the ink ejecting surface 361, and therefore the end portion 821B is less suppressed from recovering the linear posture. In this variation, however, the abutment member 84 is provided at the position corresponding to the end portion 821B of the distal portion, which leaves the ink ejecting surface 361 last, and therefore the elastic deformation produced by the end portion 821B is reduced. Therefore, the amount of ink that splashes around, owing to the elastic deformation that takes place when the end portion 821B which leaves the ink ejecting surface 361 last is released from the pressure thereof, can be reduced (first advantageous effect).

Further, since the abutment member 84 makes contact with only a part of the distal edge portion of the wiper element 821 in the aforementioned direction (direction of the angle α), a less amount of the ink stuck to the wiper element 821 is transferred to the abutment member 84, than in the case where the abutment member 84 makes contact with the entirety of the distal edge portion of the wiper element 821 in the same direction. Therefore, even though the ink stuck to the abutment member 84 is accumulated thereon, a less amount of the ink stuck to the abutment member 84 is transferred to the sheet P, when the sheet P passes by the abutment member 84 in the printing operation (second advantageous effect).

With the mentioned advantageous effects, namely the first and second advantageous effects, the configuration according to this variation more effectively suppresses the appearance of defective images, originating from the ink stuck to the abutment member 84.

The configurations and processings according to the foregoing embodiment, described with reference to FIG. 1 to FIG. 12B, are merely exemplary and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is;:

1. An ink jet recording apparatus comprising:
a recording head including an ink ejecting surface, oriented downward and including a plurality of ink outlets through which ink is ejected, and a cleaning solution supplier;
a wiper element formed in a plate shape, and configured to perform a cleaning operation including wiping the ink ejecting surface by moving in a predetermined wiping direction, with a distal edge portion of the wiper element kept in contact with the ink ejecting surface with pressure;
a driver device that drives the wiper element;
a control device including a processor, and configured to act, when the processor executes a control program, as a controller that controls the driver device to cause the wiper element to perform the cleaning operation; and
an abutment member provided downstream of the ink ejecting surface in the wiping direction, to be contacted by the distal edge portion of the wiper element, after the wiper element has wiped the ink ejecting surface,
wherein, to perform the cleaning operation, the controller moves the wiper element to pass over the ink ejecting surface in the wiping direction, from a travel start position where the wiper element is in contact with the cleaning solution supplier, to an end position corresponding to the abutment member, moves the wiper element in a vertical descending direction at the end position, and performs, a predetermined number of times, an operation including: bringing the wiper element into contact with the abutment member by moving the wiper element in a direction opposite to the vertical descending direction; and moving the wiper element in the vertical descending to separate the wiper element from the abutment member direction.

2. The ink jet recording apparatus according to claim 1,
wherein as the predetermined number of times, the controller performs the operation twice, the operation including: bringing the wiper element into contact with the abutment member by moving the wiper element in the direction opposite to the vertical descending direction; and moving the wiper element in the vertical descending to separate the wiper element from the abutment member direction.

3. The ink jet recording apparatus according to claim 1,
wherein the abutment member is formed as a sloped surface such that a contact surface contacting with the distal edge portion of the wiper element becomes apart from the distal edge portion, as the wiper element moves farther away from the ink ejecting surface in the wiping direction, and
to perform the cleaning operation, the controller moves the wiper element to pass over the ink ejecting surface in the wiping direction, from the travel start position where the wiper element is in contact with the cleaning solution supplier, to the end position corresponding to the abutment member, moves the wiper element in the vertical descending direction at the end position, moves the wiper element in a direction opposite to the wiping direction to a predetermined position corresponding to an end portion of the sloped surface of the abutment member adjacent to the ink ejecting surface, and performs, a predetermined number of times, an operation including: bringing the wiper element into contact with the abutment member by moving the wiper element in the direction opposite to the vertical descending direction; and moving the wiper element in the vertical descending to separate the wiper element from the abutment member direction.

4. The ink jet recording apparatus according to claim 1,
wherein the wiper element is oriented, when viewed in a direction orthogonal to the ink ejecting surface, such that the distal edge portion extends in a direction inclined by a predetermined angle wider than 0 degrees with respect to a direction orthogonal to the wiping direction.

5. The ink jet recording apparatus according to claim 3,
wherein, when viewed in a direction orthogonal to the ink ejecting surface, a boundary between the abutment member and the ink ejecting surface is linear, and an angle defined between the boundary and the distal edge portion of the wiper element is wider than 0 degrees.

6. The ink jet recording apparatus according to claim 4,
wherein the abutment member is located at a position corresponding to an end portion of the distal edge portion that leaves the ink ejecting surface last, in the direction in which the distal edge portion extends, when the wiper element finishes the cleaning operation.

7. The ink jet recording apparatus according to claim 3,
wherein the predetermined number of times is twice.

8. The ink jet recording apparatus according to claim 3,
wherein the contact surface of the abutment member is less ink repellent than the ink ejecting surface.
